(19) United States
(12) Patent Application Publication
(10) Pub. No.: US 2017/0229761 A1
(43) Pub. Date: Aug. 10, 2017

(54) ANTENNA DEVICE ADN PORTABLE WIRELESS DEVICE USING THE SAME

(71) Applicant: TDK Corporation, TOKYO (JP)

(72) Inventors: TOSHIO TOMONARI, TOKYO (JP); Toshifumi KOMACHI, TOKYO (JP); Hirohumi ASOU, TOKYO (JP)

(73) Assignee: TDK Corporation, TOKYO (JP)

(21) Appl. No.: 15/422,765

(22) Filed: Feb. 2, 2017

(30) Foreign Application Priority Data
Feb. 4, 2016 (JP) 2016-020045

(51) Int. Cl. H01Q 1/24; H01Q 1/36; H04M 1/02

(52) U.S. Cl. CPC H01Q 1/243; H04M 1/0202; H01Q 1/36

(57) ABSTRACT

Disclosed herein is an antenna device that includes: a planar coil pattern that surrounds an inner diameter region, the inner diameter region including a center region elongated in a first direction, a first end region positioned at one side in the first direction as viewed from the center region, and a second end region positioned at other side in the first direction as viewed from the center region; and a metal layer that covers the planar coil pattern, the metal layer including a first slit that overlaps a part of the first end region and a second slit that is formed separately from the first slit and overlaps a part of the second end region.

### BACKGROUND OF THE INVENTION

Field of the Invention

The present invention relates to an antenna device and a portable wireless device provided with the antenna device and, more particularly, to an antenna device suitable for NFC (Near Field Communication) and a portable wireless device provided with the antenna device.

Description of Related Art

In recent years, an RFID (Radio Frequency Identification) system is implemented in a portable wireless device such as a smartphone, and such a portable wireless device is provided with an antenna device for performing near field communication with a reader/writer as a communication means. As an antenna device of such a type, those described in Japanese Patent No. 4,687,832, and Japanese Patent Application Laid Open Nos. 2002-111363, and 2013-162195 are known.

The antenna devices described in the above publications are provided with a planar coil pattern and a metal layer covering the planar coil pattern, wherein an inner diameter region of the planar coil pattern overlaps an opening part of the metal layer.

In the antenna devices described in the above publications, it is necessary to form an opening part of the metal layer having substantially the same size as that of the inner diameter region of the planar coil pattern. However, in recent years, there are increasing number of portable wireless devices having a metal casing in view of reduction in thickness and weight, improvement in durability against impact of, e.g., dropping, and enhancement in design. In such a case, the metal layer serving as a part of the casing constitutes the antenna device, so that the opening part cannot be freely formed in the metal layer.

Further, in order to extend a magnetic flux radiated from the antenna device, a planar coil pattern is preferably formed into an elongated rectangular planar shape, not a square shape. In this case, however, in the antenna devices described in the above publications, a very long opening part needs to be formed in the metal layer. To form such an opening part is not realistic particularly when the metal layer constitutes a part of the casing.

### SUMMARY

An object of the present invention is therefore to provide an antenna device capable of reducing restrictions on the shape of the metal layer covering the planar coil pattern and extending a magnetic flux, and a portable wireless device provided with the antenna device.

An antenna device according to the present invention includes a planar coil pattern and a metal layer that covers the planar coil pattern. An inner diameter region surrounded by the planar coil pattern includes a center region elongated in a first direction, a first end region positioned at one side in the first direction as viewed from the center region and a second end region positioned at the other side in the first direction as viewed from the center region. The metal layer includes a first slit that overlaps a part of the first end region and a second slit that is formed separately from the first slit and overlaps a part of the second end region.

A portable wireless device according to the present invention includes the above antenna device.

According to the present invention, the separately formed slits are formed at the both sides of the inner diameter region in the longitudinal direction, making it possible to largely extend a magnetic flux radiated from the antenna device and to increase the density of the magnetic flux. Thus, when the antenna device according to the present invention is used as an antenna for NFC, it is possible to increase a communication distance as compared with a conventional one. In addition, a large opening part need not be formed in the metal layer, so that when the metal layer constitutes a part of the casing of the portable wireless device, design restrictions can be reduced.

In the present invention, the center region, a part of the first end region that does not overlap the first slit, and a part of the second end region that does not overlap the second slit are preferably covered with the metal layer. With this configuration, a metal layer having a large area can be used, which is especially suitable for a case where the metal layer constitutes a part of the casing of the portable wireless device.

In this case, the width of the inner diameter region in the second direction that crosses the first direction is preferably smaller in the center region than in the first and second end regions. With this configuration, magnetic fluxes at parts of the conductor pattern constituting the planar coil pattern that sandwich the center region cancel each other, so that an eddy current generated in a part of the metal layer that covers the center region can be reduced.

Further, in this case, it is preferable that the first and second slits extend in the first direction and that the width of each of the first and second slits in the second direction is smaller than the width of each of the first and second end regions in the second direction. With this configuration, a magnetic flux radiated from the antenna device can be intensified.

In the present invention, the first and second slits may be formed so as to cross the first and second end regions, respectively. With this configuration, the metal layer that covers each of the first and second end portions is divided into two sections, so that a magnetic flux can be intensified further by the metal layer.

In the present invention, the metal layer may further include a third slit that overlaps the center region. With this configuration, a magnetic flux can be radiated from the center region as well.

Thus, according to the present invention, there can be provided an antenna device capable of reducing restrictions on the shape of the metal layer covering the planar coil pattern and more widely extending a magnetic flux, and a portable wireless device provided with the antenna device.

### BRIEF DESCRIPTION OF THE DRAWINGS

The above and other objects, features and advantages of this invention will become more apparent by reference to the following detailed description of the invention taken in conjunction with the accompanying drawings, wherein:

FIG. 1 is a schematic perspective view illustrating a configuration of a portable wireless device provided with an antenna device according to a first embodiment of the present invention;

FIG. 2 is a plan view transparently illustrating a configuration of the antenna device shown in FIG. 1;

FIGS. 3A and 3B are cross-sectional views taken along a line A-A of FIG. 2 and a line B-B of FIG. 2, respectively;

FIG. 4 is a partially enlarged view of the antenna device shown in FIG. 1;

FIG. 5 is a plan view transparently illustrating a configuration of an antenna device according to a second embodiment of the present invention;

FIG. 6 is a plan view transparently illustrating a configuration of an antenna device according to a third embodiment of the present invention;

FIG. 7 is a plan view transparently illustrating a configuration of an antenna device according to a fourth embodiment of the present invention;

FIG. 8 is a plan view transparently illustrating a configuration of an antenna device according to a fifth embodiment of the present invention;

FIG. 9 is a plan view transparently illustrating a configuration of an antenna device according to a sixth embodiment of the present invention;

FIG. 10 is a plan view transparently illustrating a configuration of an antenna device according to a seventh embodiment of the present invention; and

FIG. 11 is a plan view transparently illustrating a configuration of an antenna device according to an eighth embodiment of the present invention.

### DETAILED DESCRIPTION OF THE EMBODIMENTS

Preferred embodiments of the present invention will now be explained in detail with reference to the drawings.

### First Embodiment

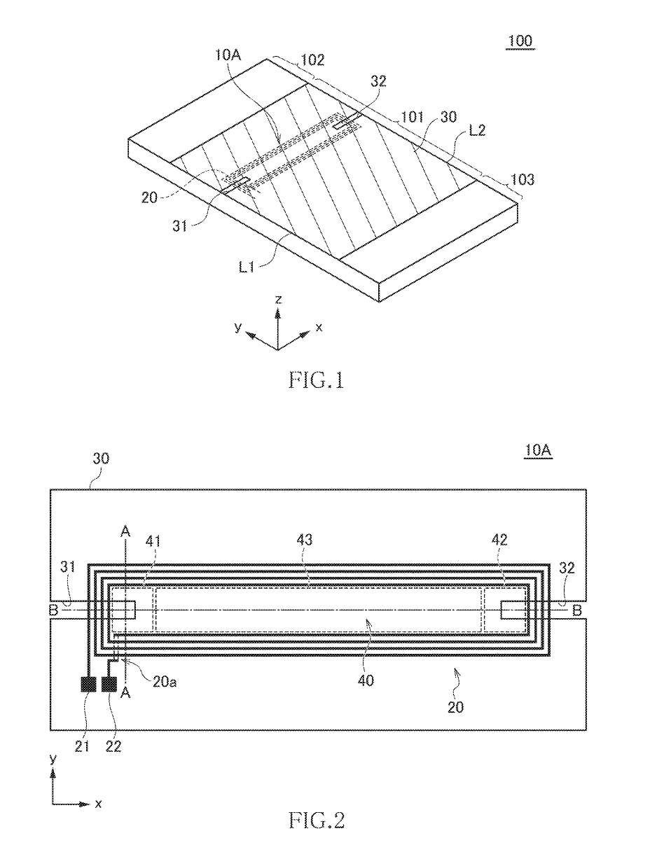

FIG. 1 is a schematic perspective view illustrating a configuration of a portable wireless device 100 provided with an antenna device 10A according to the first embodiment of the present invention.

The portable wireless device 100 illustrated in FIG. 1 is, e.g., a smartphone and has a thin box-like casing. FIG. 1 is a view illustrating the portable wireless device 100 as viewed from the back surface side of the portable wireless device 100. Thus, the front surface of the portable wireless device 100 on which a display and the like are provided faces downward. The casing of the portable wireless device 100 is formed of a combination of resin and metal. A center part 101 corresponding to a wide area on the back surface is mainly formed of a metal layer 30. The both ends of the casing in the longitudinal direction (y-direction) as viewed from the center part 101 are formed of resin cover layers 102 and 103, respectively. The reason that the wide area on the back surface of the casing is formed of the metal layer 30 is mainly for improving mechanical strength, magnetic shielding characteristics, and design of the casing.

The portable wireless device 100 incorporates therein a spiral-shaped planar coil pattern 20. The majority of the planar coil pattern 20 is covered with the metal layer 30 constituting the casing, so that, actually, the planar coil pattern 20 cannot be seen from outside. As illustrated in FIG. 1, first and second slits 31 and 32 are formed in the metal layer 30. The slit 31 has a shape obtained by cutting, in the x-direction, a part of an edge L1 of the metal layer 30 extending in the y-direction, and the slit 32 has a shape obtained by cutting, in the x-direction, a part of an edge L2 of the metal layer 30 extending in the y-direction. The slits 31 and 32 are not connected but separated from each other, so that the metal layer 30 is not divided by the slits 31 and 32.

As illustrated in FIG. 1, the planar coil pattern 20 partially overlaps the slits 31 and 32, and parts thereof that overlap the slits 31 and 32, respectively, are exposed from the metal layer 30. However, the slits 31 and 32 are embedded by a resin or the like, so that the planar coil pattern 20 is not exposed from the casing.

The planar coil pattern 20 and the metal layer 30 that covers the planar coil pattern 20 constitute the antenna device 10A according to the present embodiment. The planar coil pattern 20 is connected to a non-illustrated RF circuit incorporated in the portable wireless device 100. Thus, the antenna device 10A according to the present embodiment can be used for, e.g., 13.56 MHz NFC.

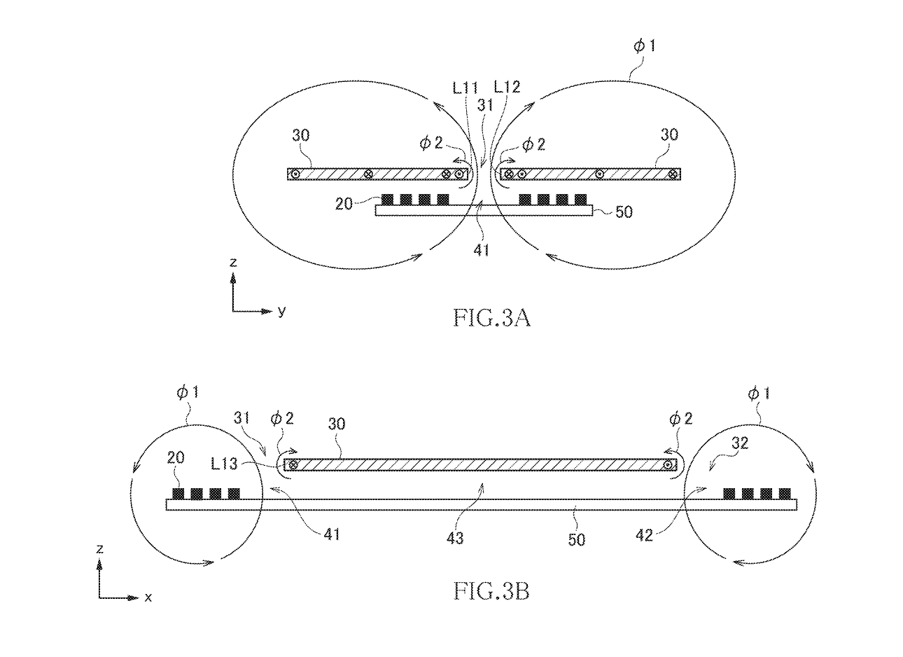

FIG. 2 is a plan view transparently illustrating a configuration of the antenna device 10A. FIGS. 3A and 3B are cross-sectional views taken along a line A-A of FIG. 2 and a line B-B of FIG. 2, respectively.

In the present embodiment, the planar coil pattern 20 is formed into a rectangular planar shape elongated in the x-direction, and the number of turns thereof is, e.g., four. Thus, a conductor pattern constituting the planar coil pattern 20 has a part extending in the x-direction and a part extending in the y-direction, and the former is longer than the latter. Terminals 21 and 22 illustrated in FIG. 2 are terminals connected to a non-illustrated RF circuit. The terminal 21 is connected to the outer peripheral end of the planar coil pattern 20, and the terminal 22 is connected to the inner peripheral end of the planar coil pattern 20 through a crossing part 20a that crosses the conductor pattern. As illustrated in FIGS. 3A and 3B, the planar coil pattern 20 is formed on a single substrate 50 formed of a PET resin, and the crossing part 20a that crosses the conductor pattern is formed on, e.g., the back surface of the substrate 50.

As illustrated in FIG. 2, an inner diameter region 40 surrounded by the planar coil pattern 20 has a rectangular shape elongated in the x-direction. The inner diameter region 40 refers to the XY plane surrounded by the innermost turn of the planar coil pattern 20. Here, a part of the inner diameter region 40 that is positioned at one end portion (left side in FIG. 2) in the x-direction is defined as a first end region 41, a part of the inner diameter region 40 that is positioned at the other end portion (right side in FIG. 2) in the x-direction is defined as a second end region 42, and a region positioned between the first and second end regions 41 and 42 is defined as a center region 43. In this case, in the present embodiment, a part of the first end region 41 overlaps the slit 31, and a part of the second end region 42 overlaps the slit 32. The residual part of the first end region 41, the residual part of the second end region 42, and the entire surface of the center region 43 are covered with the metal layer 30.

While a geometric characteristic point does not exist at the boundary between the center region 43 and end regions 41 and 42 when the inner diameter region 40 has a simple rectangular shape as in the present embodiment, the center region 43 is defined such that the x-direction thereof is the longitudinal direction.

As illustrated in FIG. 2, the width of each of the slits 31 and 32 in the y-direction is smaller than the width of each of the end regions 41 and 42 in the y-direction. Therefore, both sides of each of the end regions 41 and 42 in the y-direction as viewed from each of the slits 31 and 32 are covered with the metal layer 30. A part of each of the end regions 41 and 42 that is covered with the metal layer 30 functions as an accelerator that intensifies a magnetic flux generated by the planar coil pattern 20. Further, a part of the metal layer 30 that is positioned outside the planar coil pattern 20 extends a magnetic flux generated by the planar coil pattern 20.

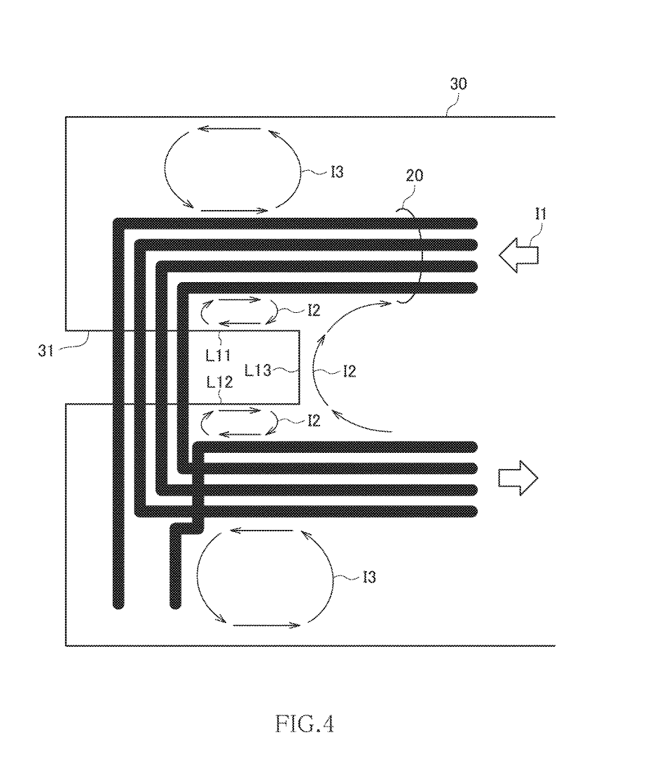

FIG. 4 is a partially enlarged view of the antenna device 10A, which explains a function obtained when current is made to flow in the planar coil pattern 20.

As illustrated in FIG. 4, when a counterclockwise current I1 is made to flow in the planar coil pattern 20, a magnetic flux φ1 (see FIG. 3) is generated, and this magnetic flux φ1 circulates widely around the metal layer 30. This widens a range of the magnetic flux to thereby increase a communication distance and widen antenna directivity.

On the other hand, current flows in the metal layer 30 in a direction canceling the magnetic flux φ1. Specifically, a current I2 illustrated in FIG. 4 flows in the inner diameter region 40 surrounded by the planar coil pattern 20, and a current I3 illustrated in FIG. 4 flows in a region outside the planar coil pattern 20. The current I2 generates a magnetic flux φ2 in the same direction as the magnetic flux φ1 passing through the slits 31 and 32 and thus serves as an accelerator, thereby further increasing a communication distance. In the present embodiment, the magnetic fluxes φ2 are generated in the same direction respectively from three edges L11 to L13 constituting the slit 31. The magnetic fluxes φ2 generated from the respective edges L11 and L12 are illustrated in FIG. 3A, and the magnetic flux φ2 generated from the edge L13 is illustrated in FIG. 3B.

In the present embodiment, the slits 31 and 32 are positioned at both end portions of the planar coil pattern 20 in the longitudinal direction, so that a region having a high flux density is distributed in two places. This widens the range of the magnetic flux to a large extent to thereby increase a communication distance and widen antenna directivity. Such an effect is considered to be obtained by locating two or more planar coil patterns at different planar positions. In this case, however, not only the number of components is increased, but also wirings need to be provided so as to connect the plurality of planar coil patterns. On the other hand, in the present embodiment, the single planar coil pattern 20 formed on the single substrate 50 is used to constitute the antenna device 10A, so that the above problem does not occur.

Thus, when the antenna device 10A according to the present embodiment is used as an antenna for NFC, it is possible to increase a communication distance as compared with a conventional one without having to make the antenna structure complicate. In addition, a large opening part need not be formed in the metal layer 30, so that when the metal layer 30 is used as a part of the casing of the portable wireless device 100, design restrictions can be reduced.

### Second Embodiment

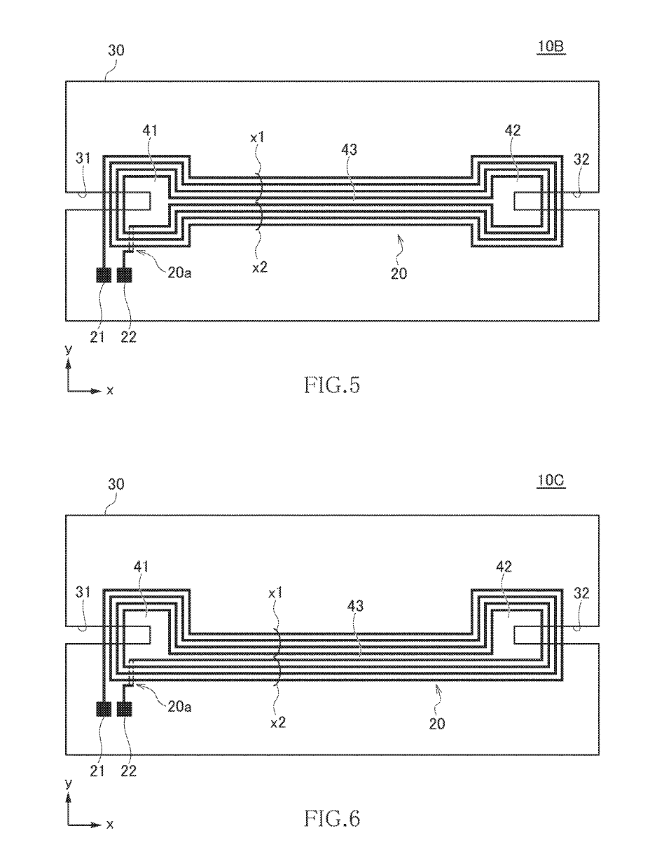

FIG. 5 is a plan view transparently illustrating a configuration of an antenna device 10B according to the second embodiment of the present invention.

The antenna device 10B according to the second embodiment differs from the antenna device 10A according to the first embodiment in that the width of the center region 43 in the y-direction is reduced. Other configurations are basically the same as those of the antenna device 10A according to the first embodiment. Thus, the same reference numerals are given to the same elements, and overlapping description will be omitted.

As illustrated in FIG. 5, in the present embodiment, of the conductor pattern constituting the planar coil pattern 20, patterns X1 and X2 extending in the x-direction are in proximity to each other at their center portions, with the result that the width of the center region 43 in the y-direction is significantly reduced. The center portions of the respective patterns X1 and X2 are portions that define the width of the center region 43 in the x-direction. Although not especially limited, the distance between the innermost turn of the pattern X1 and the innermost turn of the pattern X2 is preferably reduced to approximately the same degree as the distance between adjacent wiring patterns. The shape of each of the end regions 41 and 42 is substantially the same as that in the first embodiment.

With this configuration, a magnetic flux generated by current flowing in the pattern X1 and a magnetic flux generated by current flowing in the pattern X2 cancel each other, so that an eddy current generated in a part of the metal layer 30 that overlaps the center region 43 is reduced. As a result, it is possible to obtain higher antenna efficiency than that in the antenna device 10A according to the first embodiment.

### Third Embodiment

FIG. 6 is a plan view transparently illustrating a configuration of an antenna device 10C according to the third embodiment of the present invention.

The antenna device 10C according to the third embodiment differs from the antenna device 10B according to the second embodiment in that the pattern X2 linearly extends. Other configurations are basically the same as those of the antenna device 10B according to the second embodiment. Thus, the same reference numerals are given to the same elements, and overlapping description will be omitted. Even in this configuration, a magnetic flux generated by current flowing in the pattern X1 and a magnetic flux generated by current flowing in the pattern X2 cancel each other, so that an eddy current generated in apart of the metal layer 30 that overlaps the center region 43 is reduced. As a result, it is possible to obtain the same effect as that of the antenna device 10B according to the second embodiment.

### Fourth Embodiment

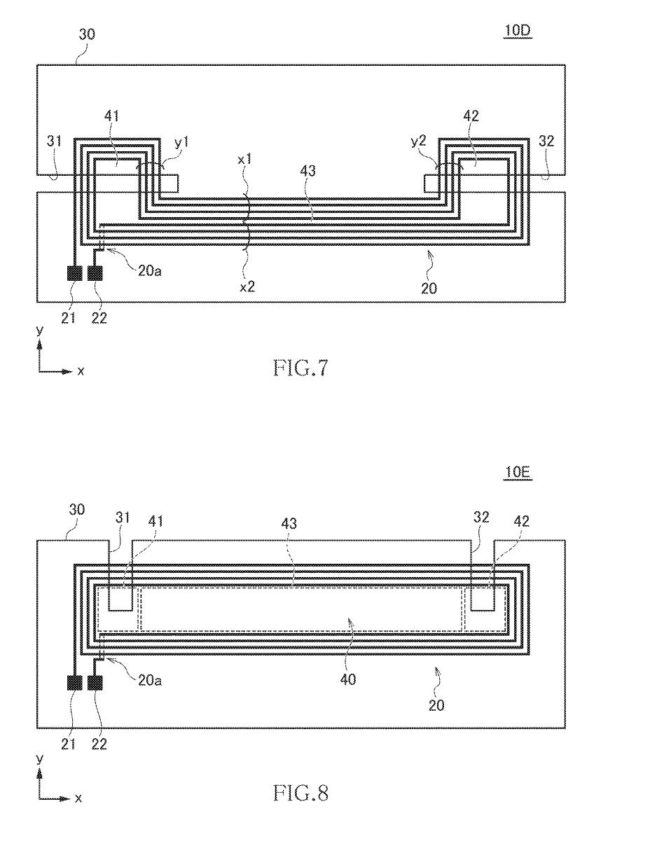

FIG. 7 is a plan view transparently illustrating a configuration of an antenna device 10D according to the fourth embodiment of the present invention.

The antenna device 10D according to the fourth embodiment differs from the antenna device 10C according to the third embodiment in that the slits 31 and 32 extend passing completely through the end regions 41 and 42, respectively. Other configurations are basically the same as those of the antenna device 10C according to the third embodiment. Thus, the same reference numerals are given to the same elements, and overlapping description will be omitted.

As illustrated in FIG. 7, in the present embodiment, the length of each of the slits 31 and 32 in the x-direction is extended. The slit 31 is extended in length in the x-direction so as to cross a pattern y1 of the conductor pattern surrounding the end region 41 that extends in the y-direction. The slit 32 is extended in length in the x-direction so as to cross a pattern y2 of the conductor pattern surrounding the end region 42 that extends in the y-direction. As a result, a part of the metal layer 30 that covers the end region 41 is divided in the y-direction into two sections by the slit 31, and a part of the metal layer 30 that covers the end region 42 is divided in the y-direction into two sections by the slit 32.

With this configuration, the current I2 illustrated in FIG. 4 flows more smoothly to increase the density of the magnetic flux φ2. This makes it possible to obtain higher antenna efficiency than that in the antenna device 10C according to the third embodiment.

### Fifth Embodiment

FIG. 8 is a plan view transparently illustrating a configuration of an antenna device 10E according to the fifth embodiment of the present invention.

The antenna device 10E according to the fifth embodiment differs from the antenna device 10A according to the first embodiment in that the slits 31 and 32 each extend in the y-direction. Other configurations are basically the same as those of the antenna device 10A according to the first embodiment. Thus, the same reference numerals are given to the same elements, and overlapping description will be omitted. Even with such a configuration, it is possible to obtain substantially the same effect as that of the antenna device 10A according to the first embodiment.

### Sixth Embodiment

FIG. 9 is a plan view transparently illustrating a configuration of an antenna device 10F according to the sixth embodiment of the present invention.

The antenna device 10F according to the sixth embodiment differs from the antenna device 10C according to the third embodiment in that the slits 31 and 32 each extend in the y-direction. Other configurations are basically the same as those of the antenna device 10C according to the third embodiment. Thus, the same reference numerals are given to the same elements, and overlapping description will be omitted. Even with such a configuration, it is possible to obtain substantially the same effect as that of the antenna device 10C according to the third embodiment.

### Seventh Embodiment

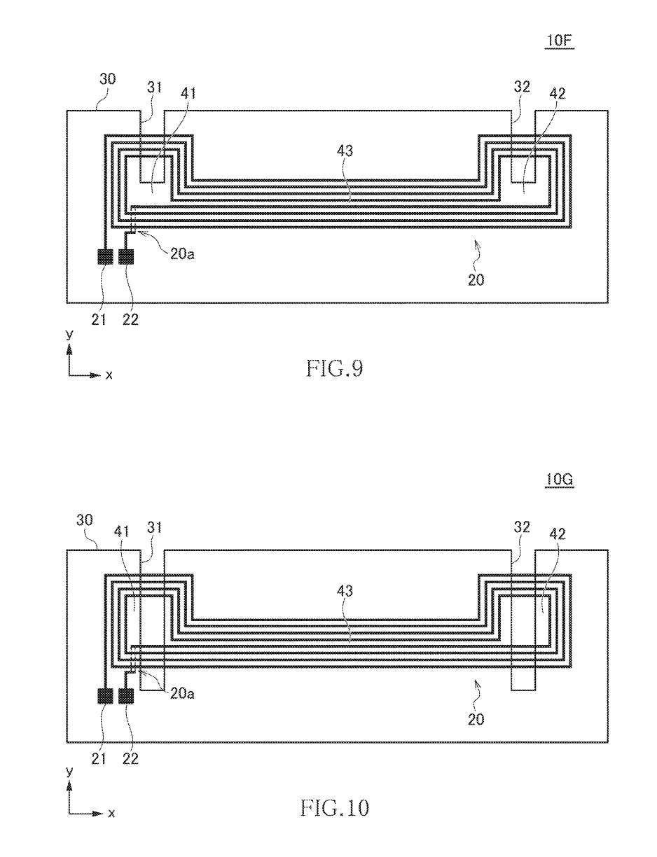

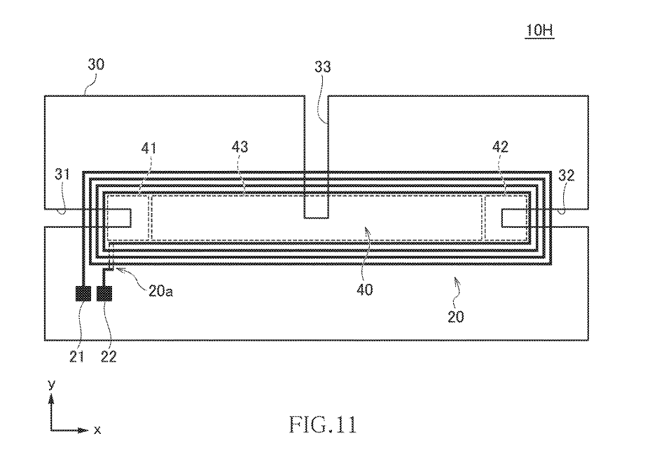

FIG. 10 is a plan view transparently illustrating a configuration of an antenna device 10G according to the seventh embodiment of the present invention.

The antenna device 10G according to the seventh embodiment differs from the antenna device 10D according to the fourth embodiment in that the slits 31 and 32 each extend in the y-direction. Other configurations are basically the same as those of the antenna device 10D according to the fourth embodiment. Thus, the same reference numerals are given to the same elements, and overlapping description will be omitted. Even with such a configuration, it is possible to obtain substantially the same effect as that of the antenna device 10D according to the fourth embodiment.

The above fifth to seventh embodiments are suitable for a case where the slits 31 and 32 are made to extend in the y-direction due to design restrictions.

### Eighth Embodiment

FIG. 11 is a plan view transparently illustrating a configuration of an antenna device 10H according to an eighth embodiment of the present invention.

The antenna device 10H according to the eighth embodiment differs from the antenna device 10A according to the first embodiment in that a slit 33 is additionally formed. Other configurations are basically the same as those of the antenna device 10A according to the first embodiment. Thus, the same reference numerals are given to the same elements, and overlapping description will be omitted.

The slit 33 extends in the y-direction, and an end portion thereof reaches the center region 43 in a plan view. With such a configuration, the magnetic flux φ1 is radiated from a part where the center region 43 and the slit 33 overlap each other, so that it is possible to obtain higher antenna efficiency than that in the antenna device 10A according to the first embodiment.

It is apparent that the present invention is not limited to the above embodiments, but may be modified and changed without departing from the scope and spirit of the invention.

For example, the shape of the planar coil pattern 20 is not limited to those described in the above-described embodiments, but may be a polygonal shape such as a hexagon or an octagon, or an elliptical shape. Further, the number of turns of the conductor pattern constituting the planar coil pattern 20 is not especially limited.

What is claimed is:

1. An antenna device comprising:
a planar coil pattern that surrounds an inner diameter region, the inner diameter region including a center region elongated in a first direction, a first end region positioned at one side in the first direction as viewed from the center region, and a second end region positioned at other side in the first direction as viewed from the center region; and
a metal layer that covers the planar coil pattern, the metal layer including a first slit that overlaps a part of the first end region and a second slit that is formed separately from the first slit and overlaps a part of the second end region.

2. The antenna device as claimed in claim 1, wherein the center region, a remaining part of the first end region without overlapping the first slit, and a remaining part of the second end region without overlapping the second slit are covered with the metal layer.

3. The antenna device as claimed in claim 2, wherein a width of the inner diameter region in a second direction that crosses the first direction is smaller in the center region than in each of the first and second end regions.

4. The antenna device as claimed in claim 3, wherein the first and second slits extend in the first direction and the width of each of the first and second slits in the second direction is smaller than the width of each of the first and second end regions in the second direction.

5. The antenna device as claimed in claim 1, wherein the first and second slits are formed so as to cross the first and second end regions, respectively.

6. The antenna device as claimed in claim 1, wherein the metal layer further include a third slit that overlaps the center region.

7. A portable wireless device having an antenna device, the antenna device comprising:
a planar coil pattern that surrounds an inner diameter region, the inner diameter region including a center region elongated in a first direction, a first end region positioned at one side in the first direction as viewed from the center region, and a second end region positioned at other side in the first direction as viewed from the center region; and
a metal layer that covers the planar coil pattern, the metal layer including a first slit that overlaps a part of the first end region and a second slit that is formed separately from the first slit and overlaps a part of the second end region.

8. The portable wireless device as claimed in claim 7, wherein the metal layer constitutes a part of a casing of the portable wireless device.

9. An antenna device comprising:
a planar coil pattern that surrounds an inner diameter region, the inner diameter region including a first region, a second region, and a third region positioned between the first and second regions; and
a metal layer that covers the planar coil pattern,
wherein a part of the first region and a part of the second region are covered with the metal layer, and
wherein an entire part of the third region is covered with the metal layer.

10. The antenna device as claimed in claim 9,
wherein the third region is positioned between the first and second regions in a first direction, and
wherein a longitudinal direction of the inner diameter region extends in the first direction.

11. The antenna device as claimed in claim 10, wherein a longitudinal direction of the third region extends in the first direction.

12. The antenna device as claimed in claim 11, wherein a width of the third region in a second direction that crosses the first direction is smaller than a width of each of the first and second regions.

13. The antenna device as claimed in claim 11,
wherein the metal layer has first and second slits,
wherein a remaining part of the first region is exposed from the metal layer via the first slit, and
wherein a remaining part of the second region is exposed from the metal layer via the second slit.

14. The antenna device as claimed in claim 13, wherein the first and second slits are independently formed so as not to divide the metal layer.

15. The antenna device as claimed in claim 14,
wherein the first slit terminates at the first region, and
wherein the second slit terminates at the second region.

16. The antenna device as claimed in claim 14, wherein the first and second slits terminates at an outside region of the planar coil pattern.
